(19) United States
(12) Patent Application Publication
(10) Pub. No.: US 2026/0063582 A1
(43) Pub. Date: Mar. 5, 2026

(54) GAS SENSOR AND METHOD OF MANUFACTURING THE SAME

(71) Applicant: ELECTRONICS AND TELECOMMUNICATIONS RESEARCH INSTITUTE, Daejeon (KR)

(72) Inventors: Seung Eon MOON, Daejeon (KR); Jeong Hun KIM, Daejeon (KR)

(21) Appl. No.: 19/242,126

(22) Filed: Jun. 18, 2025

(30) Foreign Application Priority Data
Aug. 27, 2024 (KR) 10-2024-0115427
Nov. 15, 2024 (KR) 10-2024-0163321

(51) Int. Cl. G01N 27/12; H05B 3/22

(52) U.S. Cl. CPC G01N 27/125; G01N 27/128; H05B 3/22

(57) ABSTRACT

A gas sensor and a method of manufacturing the same are disclosed. A gas sensor according to an embodiment of the present invention includes a multi-layered thin film in which a plurality of micro holes are formed and which includes a plurality of detection electrodes and a plurality of heating electrodes, a substrate which is formed under the multi-layered thin film and of which a portion of a central region is etched to form a micro chamber, and a plurality of valve structures formed on the multi-layered thin film and in which a volume of each of the plurality of valve structures changes according to a temperature.

### CROSS-REFERENCE TO RELATED APPLICATIONS

This application claims priority to and the benefit of Korean Patent Application Nos. 10-2024-0115427 and 10-2024-0163321, filed on Aug. 27, 2024, and Nov. 15, 2024, respectively, the disclosure of which is incorporated herein by reference in its entirety.

### BACKGROUND OF THE INVENTION

### 1. Field of the Invention

The present invention relates to a gas sensor and a method of manufacturing the same.

### 2. Description of Related Art

With the development of gas detection material technologies, a gas concentration which may be detected by a gas sensor has reached a level of parts per billion (ppb), and an operation time of the gas sensor for gas detection has reached a level of several seconds.

Such performance is derived by testing gas sensors in stable measurement environments such as laboratories, and the reliability of the gas sensors can be reduced in outdoor environments in which changes in a measurement environment such as sudden wind or fine dust attachment can occur.

Accordingly, a technology capable of stably measuring gas concentrations even when an environment suddenly changes is required in order to use gas sensors in portable or mobile types in outdoor environments as well as indoor environments.

The related of the present invention is disclosed in Korean Laid-open Patent No. 10-2014-0097714 (Aug. 7, 2014).

### SUMMARY OF THE INVENTION

The present invention is directed to providing a gas sensor capable of measuring a gas concentration even in a situation in which an external environment suddenly changes and a method of manufacturing the same.

According to an aspect of the present invention, there is provided a gas sensor which includes a multi-layered thin film in which a plurality of micro holes are formed and which includes a plurality of detection electrodes and a plurality of heating electrodes, a substrate which is formed under the multi-layered thin film and of which a portion of a central region is etched to form a micro chamber, and a plurality of valve structures formed on the multi-layered thin film and in which a volume of each of the plurality of valve structures changes according to a temperature.

The multi-layered thin film may include a first insulating film formed on the substrate, the plurality of detection electrodes formed on the first insulating film, a first protection film formed on the first insulating film and surrounding the plurality of detection electrodes, a second insulating film formed on the first protection film, the plurality of heating electrodes formed on the second insulating film, and a second protection film formed on the second insulating film and surrounding the plurality of heating electrodes.

The substrate may be manufactured using any one of aluminum oxide (Al₂O₃), magnesium oxide (MgO), quartz, gallium-nitrogen (GaN), gallium-arsenic (GaAs), polycarbonate (PC), polyethyleneterephthalate (PET), polyethersulfone (PES), polyethylene Naphthalate (PEN), and polyimide (PI).

The detection electrodes may be formed by depositing any one metal among gold (Au), tungsten (W), platinum (Pt), and palladium (Pd), silicon, or a conductive metal oxide using any one method of a sputtering method, an e-beam method, and an evaporation method.

The heating electrodes may be formed by depositing any one metal among gold (Au), tungsten (W), platinum (Pt), and palladium (Pd), silicon, or a conductive metal oxide using any one method of a sputtering method, an e-beam method, and an evaporation method.

The multi-layered thin film may be formed by depositing a plurality of oxide silicon films or nitride silicon films using any one method of a thermal oxidation method, a sputtering method, and a chemical vapor deposition method.

The valve structures may be formed of a temperature-reactive polymer.

The plurality of valve structures may be provided to correspond to the plurality of micro holes.

The valve structures may inflate to block the micro holes when a temperature rises and contract to open the micro holes when the temperature falls.

The plurality of valve structures may be formed through a process of filling an implant mold including a patterning substrate, in which a pattern corresponding to the plurality of micro holes is formed, and a compression substrate with a temperature-reactive polymer, a process of compressing the temperature-reactive polymer using the compression substrate, a process of exposing the compressed temperature-reactive polymer, a process of removing the patterning substrate from the implant mold, a process of arranging the implant mold from which the patterning substrate is removed on the multi-layered thin film, a process of exposing the temperature-reactive polymer, and a process of removing the compression substrate.

According to another aspect of the present invention, there is provided a method of manufacturing a gas sensor, which includes forming a multi-layered thin film, which includes a plurality of detection electrodes and a plurality of heating electrodes and in which a plurality of micro holes are formed, on a substrate, forming a micro chamber in the substrate, and forming a plurality of valve structures, in which a volume of each of the plurality of valve structures changes according to a temperature, on the multi-layered thin film.

The forming of the multi-layered thin film may include forming a first insulating film on the substrate, forming the plurality of detection electrodes on the first insulating film, forming a first protection film, which surrounds the plurality of detection electrodes, on the first insulating film, forming a second insulating film on the first protection film, forming the plurality of heating electrodes on the second insulating film, and forming a second protection film, which surrounds the plurality of heating electrodes, on the second insulating film.

The forming of the micro chamber may include etching the substrate through an isotropic etching process.

The forming of the plurality of valve structures may include filling an implant mold including a patterning substrate, in which a pattern corresponding to the plurality of micro holes is formed, and a compression substrate with a temperature-reactive polymer, compressing the temperature-reactive polymer using the compression substrate, exposing the compressed temperature-reactive polymer, removing the patterning substrate from the implant mold, arranging the implant mold, from which the patterning substrate is removed, on the multi-layered thin film, exposing the temperature-reactive polymer, and removing the compression substrate.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a cross-sectional view illustrating a gas sensor according to an embodiment of the present invention;

FIG. 2 is an exemplary view for describing the gas sensor according to the embodiment of the present invention;

FIGS. 3 to 13 are cross-sectional views for describing a method of manufacturing a gas sensor according to the embodiment of the present invention; and

FIGS. 14 to 21 are cross-sectional views for describing a method of manufacturing a gas sensor according to another embodiment of the present invention.

### DETAILED DESCRIPTION OF EXEMPLARY EMBODIMENTS

Hereinafter, embodiments of a gas sensor and a method of manufacturing the same according to the present invention will be described.

Thicknesses of lines or sizes of components illustrated in the accompanying drawings may be exaggerated for clarity and convenience of description. In addition, terms described below are defined in consideration of functions in the present invention, and meanings of the terms may vary depending on, for example, a user or operator's intentions or customs. Therefore, the terms should be defined based on the content throughout this specification.

Hereinafter, embodiments of the present invention will be described in detail with reference to the accompanying drawings in order for those skilled in the art to easily perform the present invention. However, the present invention may be implemented in several different forms and is not limited to the embodiments described herein. In addition, parts irrelevant to description are omitted in the drawings in order to clearly describe the present disclosure, and the same or similar parts are denoted by the same reference numerals throughout this specification.

Throughout this specification, when a certain part “includes” a certain component, other components are not excluded unless explicitly described otherwise, and other components may further be included therein.

Throughout this specification, when a certain film (or layer) is described as being disposed on another film (or layer) or substrate, the certain film (or layer) may be directly formed on the other film (or layer) or substrate, or a third film (or layer) may be interposed therebetween.

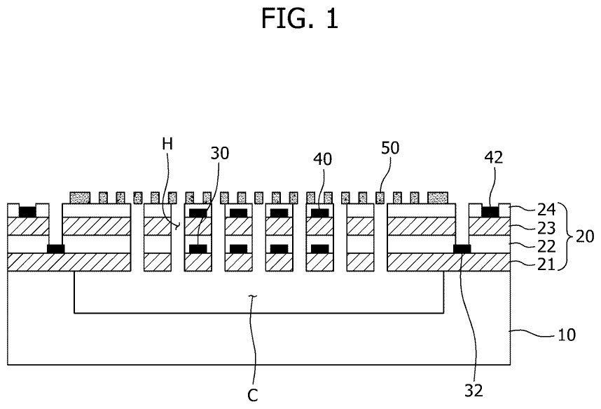

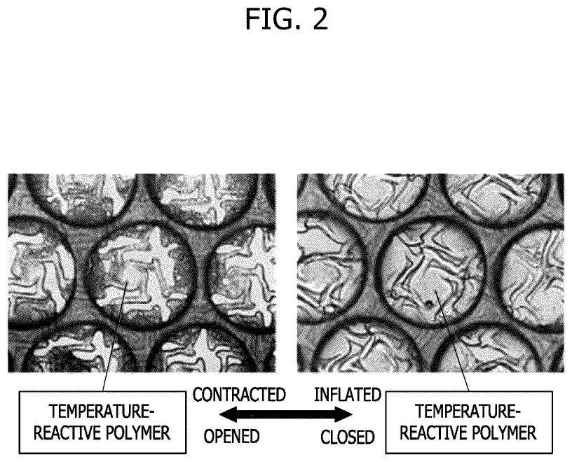

FIG. 1 is a cross-sectional view illustrating a gas sensor according to an embodiment of the present invention, and FIG. 2 is an exemplary view for describing the gas sensor according to the embodiment of the present invention.

Referring to FIG. 1, the gas sensor according to the embodiment of the present invention may include a substrate 10, a multi-layered thin film 20, a plurality of detection electrodes 30, a plurality of heating electrodes 40, and a plurality of valve structures 50.

The substrate 10 may support the multi-layered thin film (membrane) 20. A silicon substrate used in a general semiconductor process may be used as the substrate 10. A flexible substrate manufactured using any one of aluminum oxide (Al₂O₃), magnesium oxide (MgO), quartz, gallium-nitrogen (GaN), gallium-arsenic (GaAs), polycarbonate (PC), polyethyleneterephthalate (PET), polyethersulfone (PES), polyethylene Naphthalate (PEN), or polyimide (PI) may also be used as the substrate 10. A micro chamber (or recess) C may be formed in the substrate 10. The micro chamber C may be formed between the substrate 10 and the multi-layered thin film 20. The micro chamber C may be an empty space formed by etching in a central region of the substrate 10.

The multi-layered thin film 20 may be formed on the substrate 10. The multi-layered thin film 20 may be formed of a single or plurality of oxide silicon films or nitride silicon films. The multi-layered thin film 20 may be formed by a method such as thermal oxidation, sputtering, or chemical vapor deposition (CVD). The multi-layered thin film 20 may structurally support the heating electrodes 40. At least one or more micro holes H may be formed in the multi-layered thin film 20. The micro holes H may be used as passages which connect the micro chamber C and the outside. The micro holes H may be patterned through a photolithography process (photo process) and an etching process.

The multi-layered thin film 20 may include a first insulating film 21, a first protection film 22, a second insulating film 23, and a second protection film 24. The first insulating film 21 may be located between the substrate 10 and the first protection film 22, may structurally support the detection electrodes 30, and may electrically insulate the electrodes from each other. The first protection film 22 may be located between the first insulating film 21 and the second insulating film 23 and may serve to protect the detection electrodes 30. The second insulating film 23 may be located between the first protection film 22 and the second protection film 24, may structurally support the heating electrodes 40, and may electrically insulate the electrodes from each other. The second protection film 24 may be located on the second insulating film 23, may protect the heating electrodes 40, and may structurally support the valve structures 50.

The detection electrodes 30 may output a change in resistance value according to gas adsorption and desorption. The detection electrodes 30 may be formed in an inter-digital form or gap form in a central region of the multi-layered thin film 20. The detection electrodes 30 may be formed on the first insulating film 21. The detection electrodes 30 may be formed of any one metal among gold (Au), tungsten (W), platinum (Pt), and palladium (Pd), silicon, or a conductive metal oxide. The detection electrodes 30 may be formed by a method such as sputtering, e-beam, or evaporation. The detection electrodes 30 may be connected to an external circuit (not shown) through a detection electrode pad 32 and a bonding wire (not shown). The detection electrodes 30 may be connected to a gas detection material M. The gas detection material M may adsorb and burn a gas. A temperature of the gas detection material M may be changed by combustion heat, and a resistance of the gas detection material M may change according to the changed temperature. The gas detection material M may be manufactured by adding a precious metal such as platinum or palladium to a material such as a metal oxide, carbon nano tubes (CNTs), or graphene.

The heating electrodes 40 may serve to raise surrounding temperatures to improve a gas detection characteristic. The heating electrodes 40 may be formed in an inter-digital form or gap form in the central region of the multi-layered thin film 20. The heating electrodes 40 may be formed on the second insulating film 23. One or more holes may be formed in the heating electrodes 40, and the holes may be patterned through a photo process and an etching process. The heating electrodes 40 may be formed of any one metal among gold (Au), tungsten (W), platinum (Pt), and palladium (Pd), silicon, or a conductive metal oxide. The heating electrodes 40 may be formed by a method such as sputtering, e-beam, or evaporation. The heating electrode 40 may be connected to the external circuit (not shown) through a heating electrode pad 42 and a bonding wire (not shown).

In various embodiments, an attachment layer (not shown) formed of chromium (Cr), titanium (Ti), or the like to improve an adhesive force of heating electrodes 40 may be formed on multi-layered thin films 20. The attachment layer may be formed by a method such as sputtering, e-beam, or evaporation.

The valve structures 50 may serve to open or close the micro holes H formed in the multi-layered thin film 20. The valve structures 50 may be formed on the multi-layered thin film 20. A volume of each of the valve structures 50 may change according to a temperature. The valve structures 50 may be formed of a temperature-reactive polymer P. The plurality of valve structures 50 may be provided to correspond to a plurality of micro holes H. The plurality of valve structures 50 may be formed in a pattern or disposed to easily block the plurality of micro holes H formed in the multi-layered thin films 20. When a temperature rises, the valve structures may be inflated to block the micro holes H. When a temperature falls, the valve structures 50 may be contracted to open the micro holes H. The valve structure 50 is formed such that a volume is changed according to a temperature, and accordingly, a separate power source is not required.

Meanwhile, although it is described in the above embodiment that the valve structures 50 directly open or close the micro holes H, the micro holes H may be opened and closed through a separate device or polymer valve operated based on energy generated according to inflation and contraction of the valve structures 50.

When the gas sensor according to the embodiment of the present invention operates, a temperature may be raised to 100 to 300° C. by the heating electrodes 40. In this case, a volume of the valve structure 50 disposed on the multi-layered thin film 20 may inflate as illustrated in FIG. 2, and thus entrances of the micro holes H formed in the multi-layered thin film 20 may be blocked.

In addition, when the gas sensor according to the embodiment of the present invention stops operation, a temperature may fall because the heating electrode 40 does not operate. In this case, a volume of the valve structure 50 disposed on the multi-layered thin film 20 may decrease as illustrated in FIG. 2, and accordingly, the entrances of the micro holes H formed in the multi-layered thin film 20 may be opened. When the entrances of the micro holes H formed in the multi-layered thin film 20 are opened, a gas may be circulated between the micro chamber C and the outside.

As described above, in the present embodiment, when the gas sensor operates, the entrances of the micro holes H connected to the micro chamber C may be blocked, and accordingly, even in a situation in which a measurement environment suddenly changes (for example, a situation in which it is windy or fine dust increases), a gas can be stably and reliably detected.

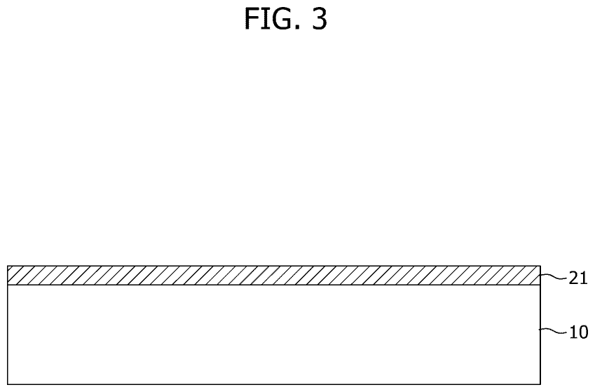

FIGS. 3 to 13 are cross-sectional views for describing a method of manufacturing a gas sensor according to the embodiment of the present invention.

Referring to FIG. 3, the first insulating film 21 may be formed on the substrate 10. The first insulating film 21 may be formed by depositing a single layered or multi-layered oxide silicon film or nitride silicon film on the polished substrate 10 using a method such as thermal oxidation, sputtering, or CVD.

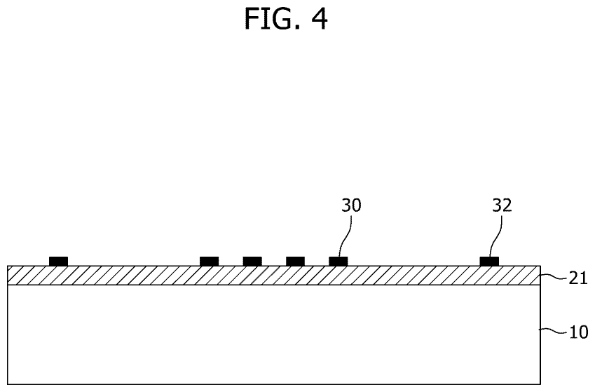

Referring to FIG. 4, the plurality of detection electrodes 30 may be formed on the first insulating film 21. The plurality of detection electrodes 30 may be formed on the first insulating film 21 by depositing a metal such as gold, tungsten, platinum, or palladium, silicon, or a conductive metal oxide on the first insulating film 21 using a method such as sputtering, e-beam, or evaporation and patterning the deposited material through a photo process and an etching process. In this case, one or more holes may be formed in the detection electrodes 30 through the patterning.

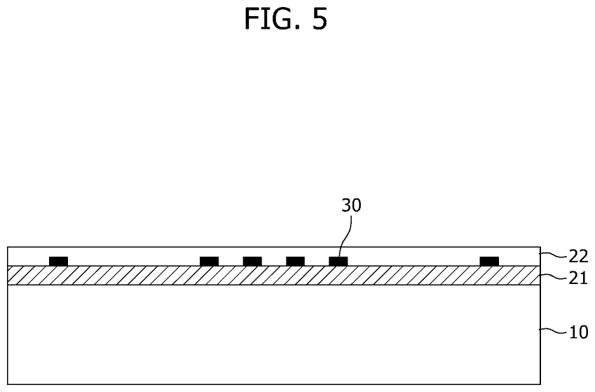

Referring to FIG. 5, the first protection film 22 surrounding the plurality of detection electrodes 30 may be formed on the first insulating film 21. The first protection film 22 may be formed by depositing a single layered or multi-layered oxide silicon film or nitride silicon film on the first insulating film 21 and the plurality of detection electrodes 30 using a method such as thermal oxidation, sputtering, or CVD and patterning the deposited film through a photo process and an etching process

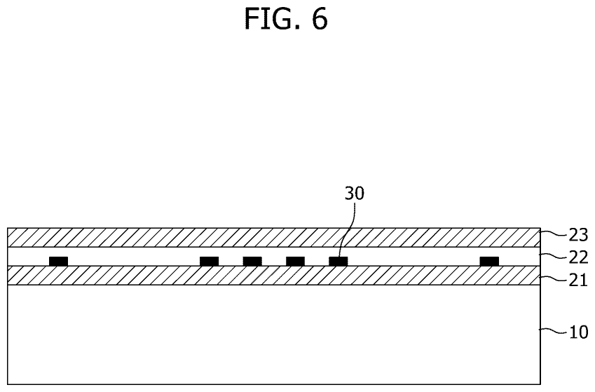

Referring to FIG. 6, the second insulating film 23 may be formed on the first protection film 22. The second insulating film 23 may be formed by depositing a single layered or multi-layered oxide silicon film or nitride silicon film on the first protection film 22 using a method such as thermal oxidation, sputtering, or CVD.

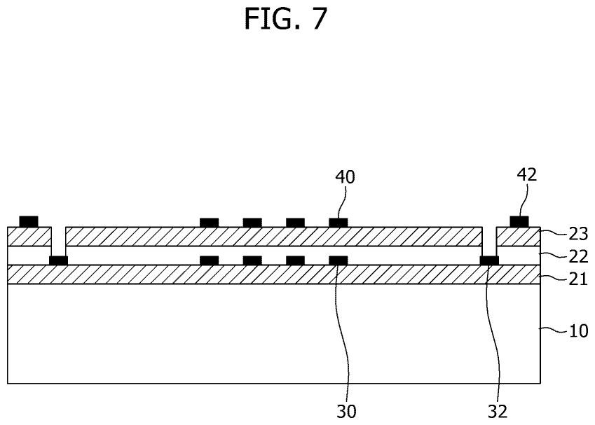

Referring to FIG. 7, the plurality of heating electrodes 40 may be formed on the second insulating film 23. The plurality of heating electrodes 40 may be formed on the second insulating film 23 by depositing a metal such as gold, tungsten, platinum, or palladium, silicon, or a conductive metal oxide on the second insulating film 23 using a method such as sputtering, e-beam, or evaporation and patterning the deposited material through a photo process and an etching process. In this case, one or more holes may be formed in the heating electrode 40 by the patterning.

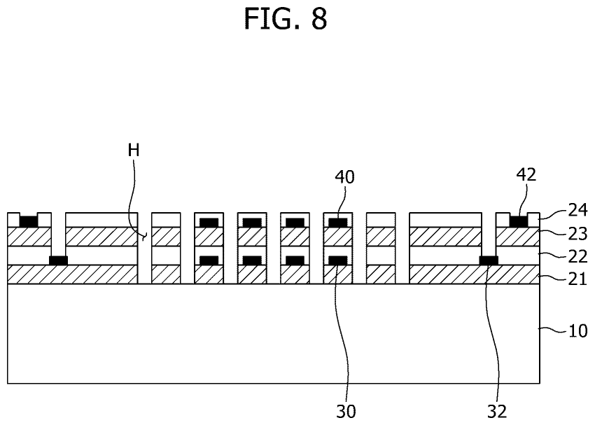

Referring to FIG. 8, the second protection film 24 surrounding the plurality of heating electrodes 40 may be formed on the second insulating film 23. The second protection film 24 may be formed by depositing a single layered or multi-layered oxide silicon film or nitride silicon film on the second insulating film 23 and the plurality of heating electrodes 40 using a method such as thermal oxidation, sputtering, or CVD and patterning the deposited film through a photo process and an etching process. In this case, one or more holes (micro holes) H may be formed in the multi-layered thin film 20 by the patterning.

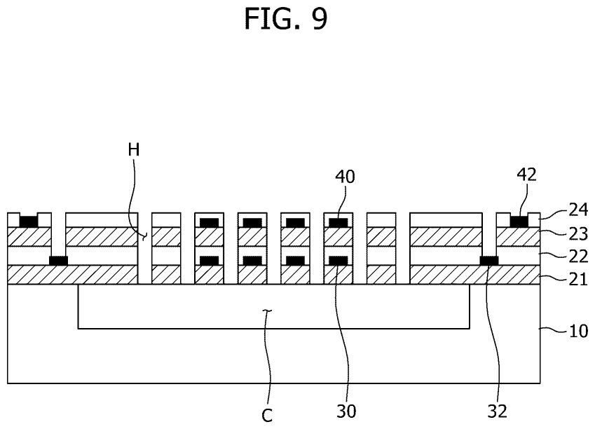

Referring to FIG. 9, the micro chamber C may be formed in the substrate 10. A central region of the substrate 10 may be partially etched to a predetermined depth in order to thermally isolate the heating electrodes 40 from the substrate 10. In this case, a region of the substrate 10 which is not exposed through the holes may be etched using an isotropic etching process. XeF₂ gas may be used in the isotropic etching process, but the present invention is not limited thereto.

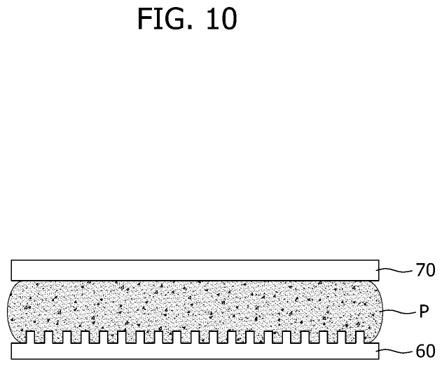

Referring to FIG. 10, the temperature-reactive polymer P may fill an implant mold including a patterning substrate 60, in which a pattern corresponding to the plurality of micro holes H is formed, and a compression substrate 70.

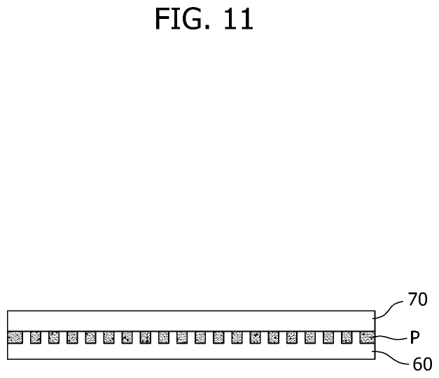

Referring to FIG. 11, the temperature-reactive polymer P may be compressed by the compression substrate 70. After the compression is performed, the temperature-reactive polymer P may be exposed to ultraviolet (UV) rays.

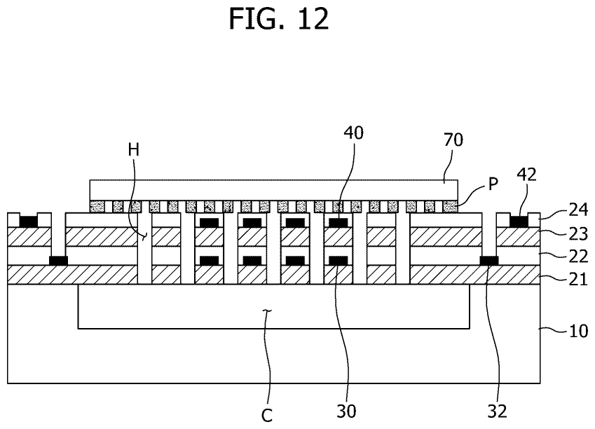

Referring to FIG. 12, the patterning substrate 60 may be removed from the implant mold, and the implant mold (together with the compression substrate 70 and the temperature-reactive polymer P) from which the patterning substrate 60 is removed may be disposed on the multi-layered thin film 20 (the second protection film 24). In this case, the implant mold may be disposed such that a surface of the implant mold from which the patterning substrate 60 is removed faces an upper portion of the multi-layered thin film 20. After the implant mold is disposed on the multi-layered thin film 20, the temperature-reactive polymer P may be exposed to UV rays. The temperature-reactive polymer P and the multi-layered thin film 20 (the second protection film 24) may be integrated in a hybrid manner by the UV exposure.

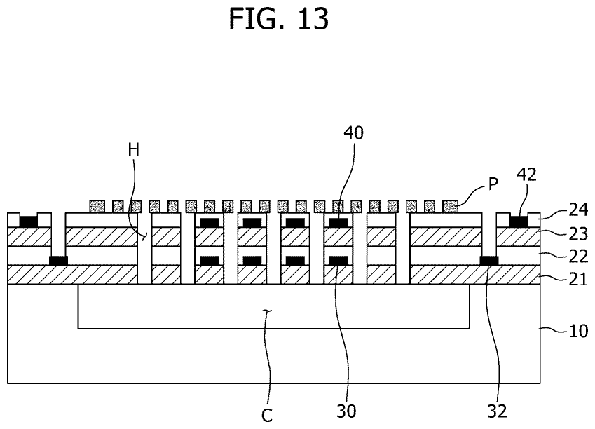

Referring to FIG. 13, the compression substrate 70 may be removed. That is, the compression substrate 70 may be detached, and manufacture of the gas sensor may be completed with the detachment of the compression substrate 70.

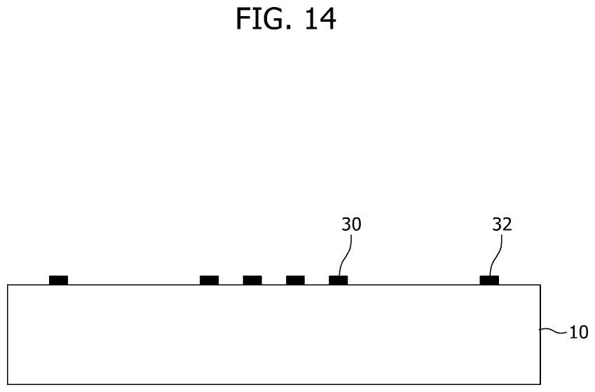

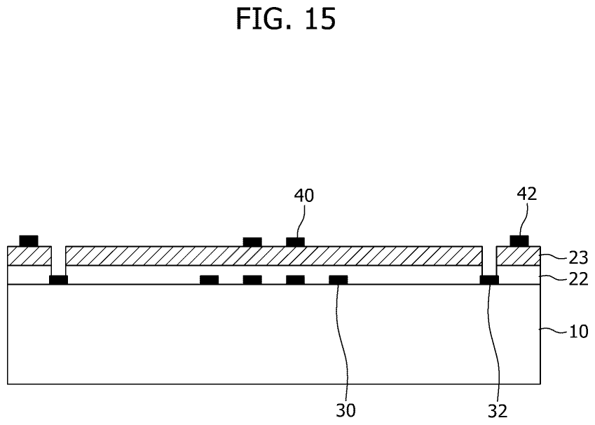

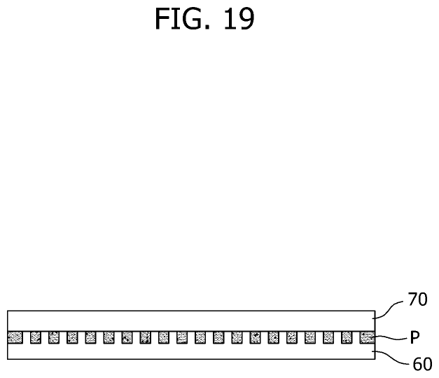

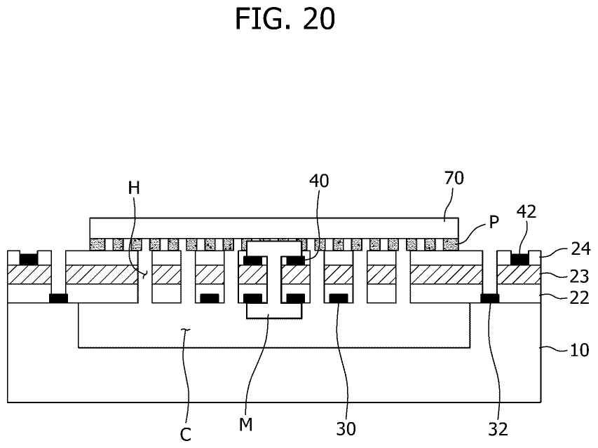

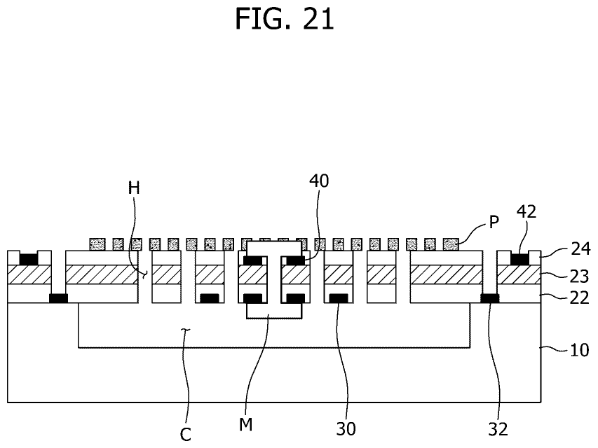

FIGS. 14 to 21 are cross-sectional views for describing a method of manufacturing a gas sensor according to another embodiment of the present invention. In some cases, a gas sensor may be manufactured through a process of FIGS. 15 to 21 instead of FIGS. 3 to 13.

Referring to FIG. 14, a plurality of detection electrodes 30 may be formed on a substrate 10. The plurality of detection electrodes 30 may be formed on the substrate 10 by depositing a metal such as gold, tungsten, platinum, or palladium, silicon, or a conductive metal oxide on the substrate 10 using a method such as sputtering, e-beam, or evaporation and patterning the deposited material though a photo process and an etching process.

Referring to FIG. 15, a first protection film 22 surrounding the plurality of detection electrodes 30 may be formed on the substrate 10, a second insulating film 23 may be formed on the first protection film 22, and a plurality of heating electrodes 40 may be formed on the second insulating film 23. The first protection film 22 may be formed by depositing a single layered or multi-layered oxide silicon film or nitride silicon film on the substrate 10 and the plurality of detection electrodes 30 using a method such as thermal oxidation, sputtering, or CVD and patterning the deposited film through a photo process and an etching process. The second insulating film 23 may be formed by depositing a single layered or multi-layered oxide silicon film or nitride silicon film on the first protection film 22 using a method such as thermal oxidation, sputtering, or CVD. The plurality of heating electrodes 40 may be formed on the second insulating film 23 by depositing a metal such as gold, tungsten, platinum, or palladium, silicon, or a conductive metal oxide on the second insulating film 23 using a method such as sputtering, e-beam, or evaporation and patterning the deposited film through a photo process and an etching process.

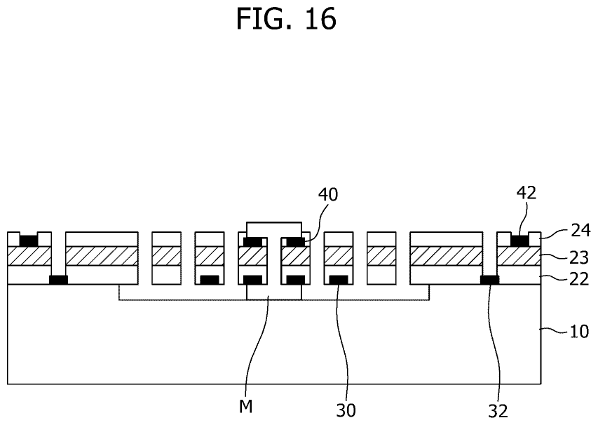

Referring to FIG. 16, a second protection film 24 surrounding the plurality of heating electrodes 40 may be formed on the second insulating film 23, a portion of a central region of the substrate 10 may be etched, and a gas detection material M may be formed to pass through a multi-layered thin film 20. The second protection film 24 may be formed by depositing a single layered or multi-layered oxide silicon film or nitride silicon film on the second insulating film 23 and the plurality of heating electrodes 40 using a method such as thermal oxidation, sputtering, or CVD and patterning the deposited film through a photo process and an etching process. A portion of the gas detection material M may be formed on the plurality of heating electrodes 40. The gas detection material M may be formed through a screen-printing process, ink-jet printing process, or the like. In this case, one or more holes (micro holes) H may be formed in the multi-layered thin film 20 by patterning.

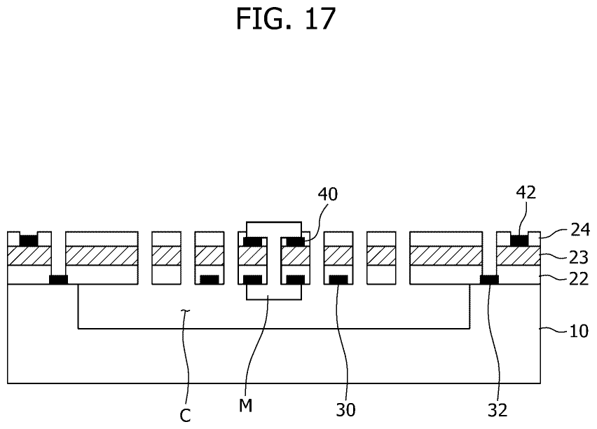

Referring to FIG. 17, a micro chamber C may be formed in the substrate 10. A central region of the substrate 10 may be partially etched to a predetermined depth in order to thermally isolate the heating electrodes 40 from the substrate 10. The micro chamber C may allow the multi-layered thin film 20 to be spatially spaced apart from the substrate 10. In some cases, a thermal treatment process may be performed after the deposition process of the gas detection material M is completed.

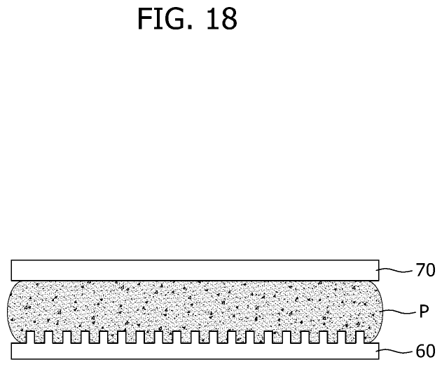

FIGS. 18 to 21 show a process in which valve structures 50 are deposited on the multi-layered thin film 20 and which may be performed through the same method as illustrated in FIGS. 10 to 13.

As described above, a gas sensor and a method of manufacturing the same according to the embodiment of the present invention can stably measure a gas concentration even in a situation in which an external environment suddenly changes, thereby improving the reliability of the gas sensor.

According to one aspect of the present invention, a gas concentration can be measured even in a situation in which an external environment suddenly changes, thereby improving the reliability of the gas sensor.

Meanwhile, effects which can be achieved from the present invention are not limited to the above-described effects, and other effects which are not described above may be clearly understood by those skilled in the art to which the present invention belongs from the above descriptions.

Although the present invention has been described with reference to embodiments illustrated in the accompanying drawings, these are merely exemplary. It will be understood by those skilled in the art that various modifications and other equivalent embodiments are possible from the embodiments of the present invention. Therefore, the scope of the present invention is defined by the appended claims.

What is claimed is:

1. A gas sensor comprising:
a multi-layered thin film in which a plurality of micro holes are formed and which includes a plurality of detection electrodes and a plurality of heating electrodes;
a substrate which is formed under the multi-layered thin film and of which a portion of a central region is etched to form a micro chamber; and
a plurality of valve structures formed on the multi-layered thin film and in which a volume of each of the plurality of valve structures changes according to a temperature.

2. The gas sensor of claim 1, wherein the multi-layered thin film includes:
a first insulating film formed on the substrate;
the plurality of detection electrodes formed on the first insulating film;
a first protection film formed on the first insulating film and surrounding the plurality of detection electrodes;
a second insulating film formed on the first protection film;
the plurality of heating electrodes formed on the second insulating film; and
a second protection film formed on the second insulating film and surrounding the plurality of heating electrodes.

3. The gas sensor of claim 1, wherein the substrate is manufactured using any one of aluminum oxide (Al₂O₃), magnesium oxide (MgO), quartz, gallium-nitrogen (GaN), gallium-arsenic (GaAs), polycarbonate (PC), polyethyleneterephthalate (PET), polyethersulfone (PES), polyethylene Naphthalate (PEN), and polyimide (PI).

4. The gas sensor of claim 1, wherein the detection electrodes are formed by depositing any one metal among gold (Au), tungsten (W), platinum (Pt), and palladium (Pd), silicon, or a conductive metal oxide using any one method of a sputtering method, an e-beam method, and an evaporation method.

5. The gas sensor of claim 1, wherein the heating electrodes are formed by depositing any one metal among gold (Au), tungsten (W), platinum (Pt), and palladium (Pd), silicon, or a conductive metal oxide using any one method of a sputtering method, an e-beam method, and an evaporation method.

6. The gas sensor of claim 1, wherein the multi-layered thin film is formed by depositing a plurality of oxide silicon films or nitride silicon films using any one method of a thermal oxidation method, a sputtering method, and a chemical vapor deposition method.

7. The gas sensor of claim 1, wherein the valve structures are formed of a temperature-reactive polymer.

8. The gas sensor of claim 7, wherein the plurality of valve structures are provided to correspond to the plurality of micro holes.

9. The gas sensor of claim 8, wherein the valve structures inflate to block the micro holes when a temperature rises and contract to open the micro holes when the temperature falls.

10. The gas sensor of claim 1, wherein the plurality of valve structures are formed through:
a process of filling an implant mold including a patterning substrate, in which a pattern corresponding to the plurality of micro holes is formed, and a compression substrate with a temperature-reactive polymer;
a process of compressing the temperature-reactive polymer using the compression substrate;
a process of exposing the compressed temperature-reactive polymer;
a process of removing the patterning substrate from the implant mold;
a process of arranging the implant mold from which the patterning substrate is removed on the multi-layered thin film;
a process of exposing the temperature-reactive polymer; and
a process of removing the compression substrate.

11. A method of manufacturing a gas sensor, comprising:
forming a multi-layered thin film, which includes a plurality of detection electrodes and a plurality of heating electrodes and in which a plurality of micro holes are formed, on a substrate;
forming a micro chamber in the substrate; and
forming a plurality of valve structures, in which a volume of each of the plurality of valve structures changes according to a temperature, on the multi-layered thin film.

12. The method of claim 11, wherein the forming of the multi-layered thin film includes:
forming a first insulating film on the substrate;
forming the plurality of detection electrodes on the first insulating film;
forming a first protection film, which surrounds the plurality of detection electrodes, on the first insulating film;
forming a second insulating film on the first protection film;
forming the plurality of heating electrodes on the second insulating film; and
forming a second protection film, which surrounds the plurality of heating electrodes, on the second insulating film.

13. The method of claim 11, wherein the forming of the micro chamber includes etching the substrate through an isotropic etching process.

14. The method of claim 11, wherein the forming of the plurality of valve structures includes:
filling an implant mold including a patterning substrate, in which a pattern corresponding to the plurality of micro holes is formed, and a compression substrate with a temperature-reactive polymer;
compressing the temperature-reactive polymer using the compression substrate;
exposing the compressed temperature-reactive polymer;
removing the patterning substrate from the implant mold;
arranging the implant mold, from which the patterning substrate is removed, on the multi-layered thin film;
exposing the temperature-reactive polymer; and
removing the compression substrate.
